(19) United States
(12) Patent Application Publication
(10) Pub. No.: US 2008/0197667 A1
(43) Pub. Date: Aug. 21, 2008

(54) Hardtop For a Cabriolet Vehicle

(75) Inventor: Michael Koch, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/659,803

(22) PCT Filed: Aug. 10, 2005
(86) PCT No.: PCT/EP2005/008675

§ 371 Date: Dec. 18, 2007

(30) Foreign Application Priority Data
Aug. 12, 2004 (DE) 10 2004 039 134.3

(51) Int. Cl. B60J 7/14

(52) U.S. Cl. 296/107.17

(57) ABSTRACT

A hardtop a convertible vehicle has at least two roof parts which can be displaced between a closed position and a stowed position. In the stowed position, the roof parts are stowed in a vehicle trunk, and can be brought into a loading position which is elevated relative to the stowed position. Furthermore, the hardtop has a folding-top actuation assembly which has at least one folding-top linkage, at least one drive device and at least one bearing device. The roof parts are coupled to the bearing device via at least one link of the folding-top linkage and can be displaced by the drive device. The bearing device has a main bearing and an intermediate bearing which is movable relative to the main bearing. The drive device has a translatory drive element and a rotatory drive elements, which are engaged with each other. The link of the folding-top linkage is connected to the rotatory drive element and is mounted such that it can rotate together with the intermediate bearing about a common pivot. A control lever is articulated on the translatory drive elements, and is guided in a guide track between the main bearing and the intermediate bearing in such a manner that it brings the roof parts into the loading position when the translatory drive element is acted upon.

This application claims the priority of German patent document 10 2004 039 134.3, filed Aug. 12, 2004 (PCT International Application No. PCT/EP2005/008675, filed Aug. 10, 2005), the disclosure of which is expressly incorporated by reference herein.

### BACKGROUND AND SUMMARY OF THE INVENTION

The invention relates to a convertible vehicle and hardtop for a convertible vehicle, with at least two roof parts which can be displaced between a closed (“top up”) position and a stowed (“top down”) position.

German patent document DE 199 60 010 C2 discloses a hardtop of the generic type and a corresponding convertible vehicle. The hardtop can be brought from its position in which it is stowed in the trunk of the vehicle into a “loading position”, in which it is possible to comfortably load the trunk and to subsequently bring the roof parts again into their stowed position.

However, a drawback of this known arrangement is that, because of the deflection required, in order to take up the loading position an additional actuating or drive device is required, in this case an additional hydraulic cylinder, which not only causes additional production and installation costs but, as an additional component, also constitutes an increased risk of failure.

It is therefore the object of the present invention to provide a hardtop for a convertible vehicle, in which, with the least possible outlay, in particular with just one drive device, a loading position can be adopted for the roof parts.

This and other objects and advantages are achieved by the hardtop configuration according to the invention, in which the drive device has a translatory and a rotatory drive element, which permits a structurally very simple coupling of the drive of the roof parts via the folding-top linkage and of the movement of the intermediate bearing in relation to the main bearing. The control lever, which is attached to the translatory drive element in an articulated manner, is thus able to bring the roof parts into the loading position when the translatory drive element is acted upon. As a result, in order to drive the hardtop according to the invention, advantageously a single drive element, comprising the translatory and the rotatory drive element, is required.

Further advantages of the hardtop configuration according to the invention are the omission of deflecting and control levers, which are required in the prior art devices, and a structural simplification of the intermediate bearing. Furthermore, the drive device for the hardtop according to the invention can be realized in a very compact manner, thus saving space, which is always advantageous in the manufacture of cars. Furthermore, the omission of the second drive device makes it possible to dispense with the limit switches which have heretofore been required, reducing the outlay on control for moving the hardtop according to the invention, and increasing the reliability.

In a particularly simple embodiment of the drive device, the translatory drive element and the rotatory drive element have intermeshing toothings.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the hardtop according to the invention in its closed position;

FIG. 2 shows the hardtop of FIG. 1 in an intermediate position;

FIG. 3 shows the hardtop of FIG. 1 in its stowed position;

FIG. 4 shows the hardtop of FIG. 1 in its loading position;

FIG. 5 is an enlarged illustration of the bearing device of the hardtop according to the invention, in the position according to FIG. 1;

FIG. 6 shows the bearing device of FIG. 5 in the position of the hardtop according to FIG. 3; and

FIG. 7 shows the bearing device of FIG. 5 in the position of the hardtop according to FIG. 4.

### DETAILED DESCRIPTION OF THE DRAWINGS

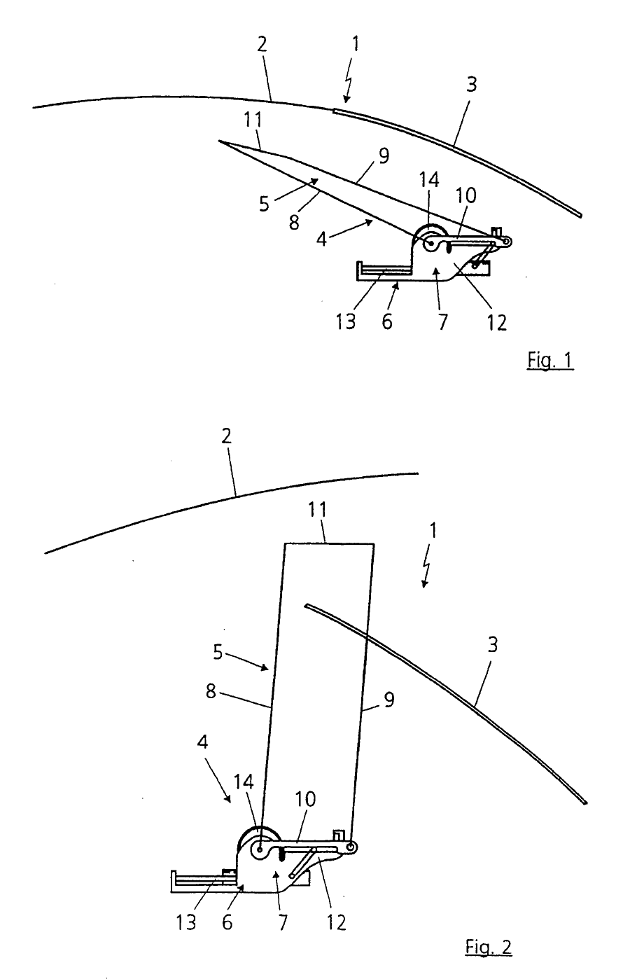

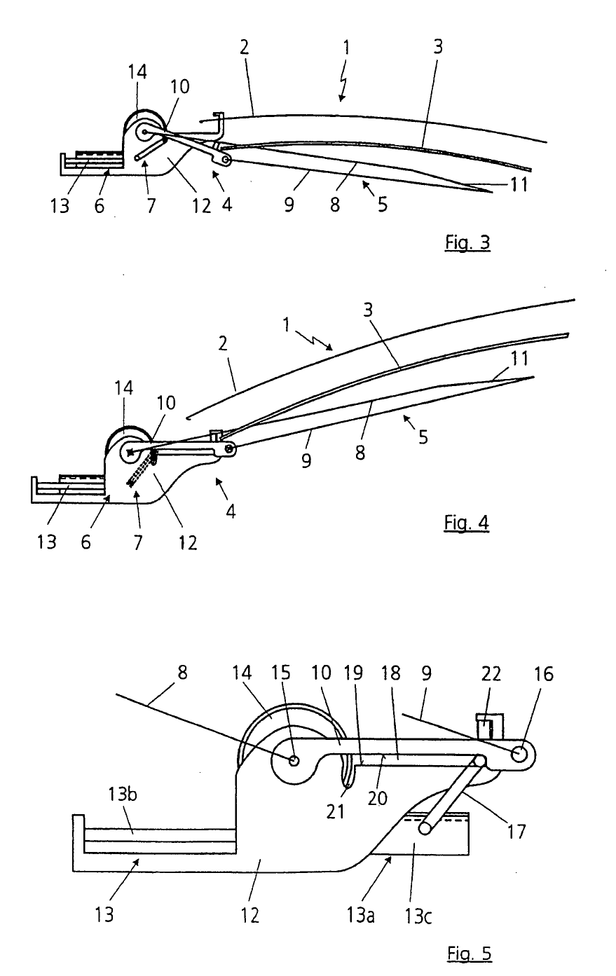

FIG. 1 shows a hardtop 1 for a cabriolet vehicle (not illustrated in its entirety). The hardtop 1 has two roof parts, namely a front roof part 2 and a rear roof part 3. In the illustration according to FIG. 1, the two roof parts 2 and 3 are in their closed position, in which they form a roof for the convertible vehicle. As described below and known, for example, from German patent document DE 199 60 010 C2, the hardtop 1 can be brought by means of a corresponding stowing movement into a stowed position, in which it is located in a trunk (not illustrated) of the cabriolet vehicle. This stowed position of the hardtop 1 is illustrated in FIG. 3. By contrast, FIG. 2 shows an intermediate position and FIG. 4 shows a “loading position”, in which the hardtop 1 is raised in relation to the stowed position in order to permit better access to the trunk of the vehicle. Should a driver or occupant of the vehicle equipped with the hardtop 1 therefore wish to load the trunk, as described in detail below, he can bring the hardtop 1 from its stowed position into the loading position, load the trunk with any desired objects and subsequently return the hardtop 1 from the loading position into the stowed position.

A folding-top drive assembly 4 according to the invention has a folding-top linkage 5, a drive device 6 and a bearing device 7, and is used to move the hardtop 1 between the positions illustrated in FIGS. 1 to 4. The folding-top linkage 5 is designed in a known manner, as a four-bar linkage which comprises a main link 8, a C-pillar link 9, an intermediate bearing 10 and an upper connecting link 11 connecting the main bearing 8 to the C-pillar link 9. The main link 8 and the C-pillar link 9 are connected to the intermediate bearing 10 in an articulated manner. In a manner which is also known per se (but cannot be seen in FIGS. 1 to 4), the front roof part 2 is attached to the upper connecting link 11 and the rear roof part 3 is attached to the C-pillar link 9.

The bearing device 7 has, in addition to the intermediate bearing 10 which forms part of the four-bar linkage, a main bearing 12 which is attached to the vehicle body (not illustrated). The drive device 6 has a translatory drive element 13 and a rotatory drive element 14, which elements are in engagement with each other. In order to ensure reliable operation of the hardtop 1 and to ensure that forces are distributed evenly over the same, two folding-top linkages 5, drive devices 6 and bearing devices 7 arranged on both sides of the hardtop 1 are provided in each case, in a manner which is known per se (but is not illustrated for simplicity).

The drive device 6 and the bearing device 7 of the hardtop 1 are described in more detail below with reference to FIGS. 5, 6 and 7.

The translatory drive element 13 of the drive device 6 has a hydraulic cylinder-piston unit 13a, the piston rod 13b of which is attached to the main bearing 12. The housing of the piston rod is formed by a rack 13c, which saves construction space. The rack 13c has a toothing which engages in a toothing 14a of the rotatory drive element 14. Thereby ensuring that the rotatory drive element 14 is driven by the translatory drive element 13. For construction space reasons, the rotatory drive element 14 may also be just a segment of a toothed wheel.

As shown in FIG. 5, the main link 8 is connected to the rotatory drive element 14 and the intermediate bearing 10 and is mounted such that it can rotate together with the intermediate bearing 10 about a common pivot 15, namely the axis of the rotatory drive element 14, to which the main link 8 is attached. (Compare FIGS. 4 and 5.) The C-pillar link 9 is connected to the intermediate bearing 10 at a further pivot 16. A control lever 17 is attached to the translatory drive element 13 in an articulated manner and is forcibly guided in a guide track 18 formed between the main bearing 12 and the intermediate bearing 10. The guide track 18 for the control lever 17 is of essentially rectilinear design, and is formed by an upper outer edge 19 of the main bearing 12 and a lower outer edge 20 of the intermediate bearing 10, which faces the outer edge 19 of the main bearing 12.

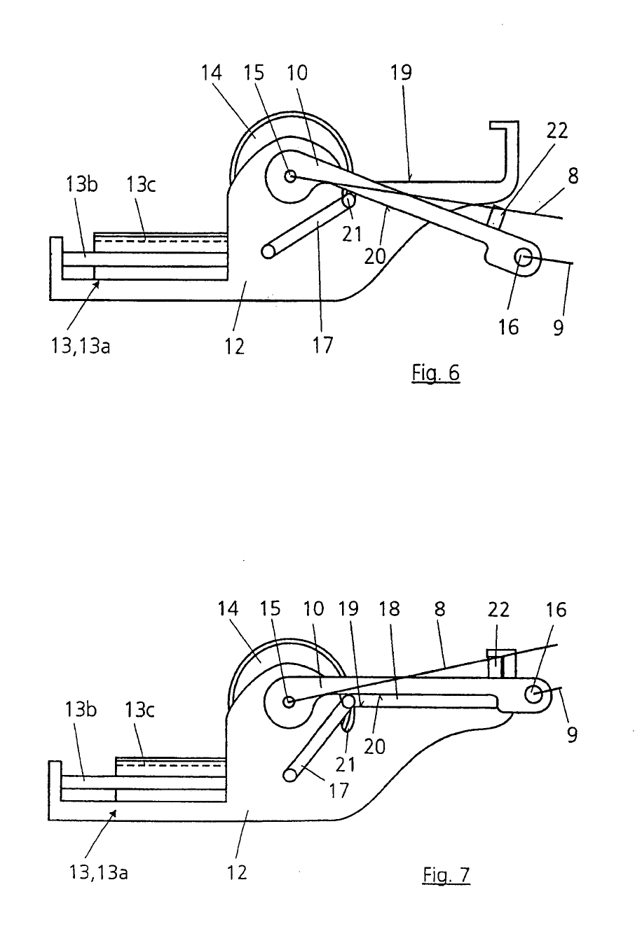

As becomes clear from a comparison of FIG. 5 with FIG. 6, when the translatory drive element 13 is acted upon in the direction of the arrow A (FIG. 5), the rack 13c moves in this direction, which causes the toothed wheel 14a to rotate in accordance with the arrow B. This movement in turn leads to the rotation of the folding-top linkage 5 and therefore of the two roof parts 2 and 3 in the direction of the put-away position.

Furthermore, the movement of the translatory drive element 13 also leads to a movement of the control lever 17, which is attached to the rack 13c, in the direction of the arrow “A” and therefore along the guide track 18. In order to bring the roof parts 2 and 3 into the put-away position. At its end facing the pivot 15, the guide track 18 has a cutout 21 into which the control lever 17 is moved by the rack 13c, so that the intermediate bearing 10 can rotate about the pivot 15 in relation to the main bearing 12. Therefore, the main link 8 and thus the two roof parts 2 and 3 are also moved further in accordance with the arrow “B”.

As long as the control lever 17 moves in the rectilinear section of the guide track 18, it is not possible to lower the intermediate bearing 10 since the control lever 17 supports the intermediate bearing 10 in relation to the main bearing 12. Such lowering occurs only if the control lever 17 reaches the cutout 21 during the movement of the translatory drive element 13 in the direction of the arrow A. Overall, this results in a continuous movement of the hardtop 1 from the closed position into the stowed position.

In order to pass from the stowed position according to FIG. 6 into the loading position illustrated in FIG. 7, the translatory drive element 13 is moved counter to the arrow direction A and therefore in the direction of the arrow A′ (FIG. 7) by appropriate action upon the hydraulic cylinder-piston unit 13a. As a result, the control lever 17 moves upward in the cutout 21, and the intermediate bearing 10 moves upward together with the main link 8 and the two roof parts 2 and 3. In order to limit this movement of the intermediate bearing 10, it has a stop 22 which bears against a rigid part of the main bearing 12 in the upper position of the intermediate bearing 10. Of course, the stop 22 for limiting the movement of the intermediate bearing 10 could also be provided on the main bearing 12.

From the loading position, the hardtop 1 can be brought again into the stowed position by moving the translatory drive element 13 in the direction of the arrow A. All of these movements of the hardtop 1 may be controlled by a control unit (not shown).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A stowable hardtop for a convertible vehicle with at least two roof parts which can be displaced between a closed position and a stowed position, and which in the stowed position, are stowed in a trunk of the vehicle and can be brought into a loading position that is elevated relative to the put-away position, and with a folding-top actuation assembly that has at least one folding-top linkage, at least one drive device and at least one bearing device; wherein the roof parts are coupled to the bearing device via at least one link of the folding-top linkage and can be displaced by means of the drive device; wherein the bearing device has a main bearing and an intermediate bearing which is movable relative to the main bearing; and wherein the drive device comprises:
a translatory drive element;
a rotatory drive element which is engaged with the translatory drive element;
a link of the folding-top linkage, which link is connected to the rotatory drive element and is mounted such that it can rotate together with the intermediate bearing about a common pivot; and
a control lever which is attached to the translatory drive element in an articulated manner and is guided in a guide track between the main bearing and the intermediate bearing in such a manner that it brings the roof parts into the loading position when the translatory drive element is acted upon.

12. The hardtop as claimed in claim 11, wherein the guide track between the main bearing and the intermediate bearing is formed by two mutually facing outer edges of the main bearing and of the intermediate bearing.

13. The hardtop as claimed in claim 11, wherein:
the guide track is substantially rectilinear; and
at one end the guide track has a cutout that permits the intermediate bearing to be lowered, to bring the roof parts into the put-away position.

14. The hardtop as claimed in claim 11, wherein the translatory drive element and the rotatory drive element have intermeshing toothings.

15. The hardtop as claimed in claim 11, further comprising a stop for limiting movement of the intermediate bearing relative to the main bearing.

16. The hardtop as claimed in claims 11, wherein the folding-top linkage is a four-bar linkage which comprises the link connected to the rotatory drive element, a C-pillar link, the intermediate bearing and an upper connecting link.

17. The hardtop as claimed in claim 11, wherein two folding-top linkages, drive devices and bearing devices are arranged on both sides of the hardtop.

18. The hardtop as claimed in claim 11, wherein the translatory drive element has a hydraulic cylinder-piston unit.

19. The hardtop as claimed in claim 18, wherein one piston rod of the hydraulic cylinder-piston unit is attached to the main bearing.

20. A convertible vehicle having a hardtop as claimed in claim 11.
